(19) United States
(12) Patent Application Publication
(10) Pub. No.: US 2002/0070930 A1
(43) Pub. Date: Jun. 13, 2002

(54) System and method for minimizing beat frequencies in electronic projectors

(75) Inventor: Donald C. Mead, Carlsbad, CA (US)

Correspondence Address: OPPENHEIMER WOLFF & DONNELLY LLP, Attn: James W. Inskeep, 500 Newport Center Drive, Suite 700, Newport Beach, CA, 92660, US

(73) Assignee: Digital Cinema Systems Corporation

(21) Appl. No.: 09/733,456

(22) Filed: Dec. 8, 2000

Related U.S. Application Data
(60) Provisional application No. 60/169,588, filed on Dec. 8, 1999.

(51) Int. Cl. G09G 5/00

(52) U.S. Cl. 345/204

(57) ABSTRACT

A novel method of preventing beat frequencies in an electronic system is disclosed. Other applications beyond electronic projectors may also benefit

### BACKGROUND OF THE INVENTION

1. Field of the Invention

The present invention provides a means of minimizing beat frequencies in an electronic projector, specifically, an electronic projector that utilizes an image light amplifier (ILA). ILAs require an AC bias voltage across the ILA layers. Since other frequencies are required to operate the projector, regardless of whether the bias voltage is independent of these frequencies or derived from one of them (or a common source), a beat frequency occurs which degrades the quality of the displayed image.

2. Description of the Related Art

Current technology utilizes a fixed frequency oscillator to provide the AC bias. The modulating light and the light being modulated create explicit or implicit signals of the form sin(ω₁*t)*sin(ω₂*t). These are the same as signals of the form sin[(ω₁*t)−(ω₂*t)] and sin[(ω₁*t)+(ω₂*t)], or sum and difference frequencies frequently called beat frequencies. These beat frequencies create degradation in the displayed image.

The beat frequencies exist because the bias voltage and the modulating/modulated light exist indefinitely. Since the modulating/modulated light is impossible to control, what is needed is a bias voltage oscillator that will not have any single frequency last for more than one cycle.

### SUMMARY OF THE INVENTION

This invention satisfies this need by using as the bias voltage an oscillator whose period changes randomly every period. Since the ILA can perform normally over a wide range of frequencies, its normal performance is not affected by this frequency variation.

### BRIEF DESCRIPTION OF THE DRAWINGS

FIG. 1 is a block diagram of an image light amplifier that shows how the bias voltage is applied across the ILA layers.

FIG. 2 is a top level block diagram of the invention

### DETAILED DESCRIPTION OF THE INVENTION

As its name implies, the ILA is an Optical component that has a low light level image at its input and can output a highly amplified replica. Using 3 such amplifiers for each of the 3 additive primary color planes (red, green, and blue) a high quality electronic projector can be designed.

Operation:

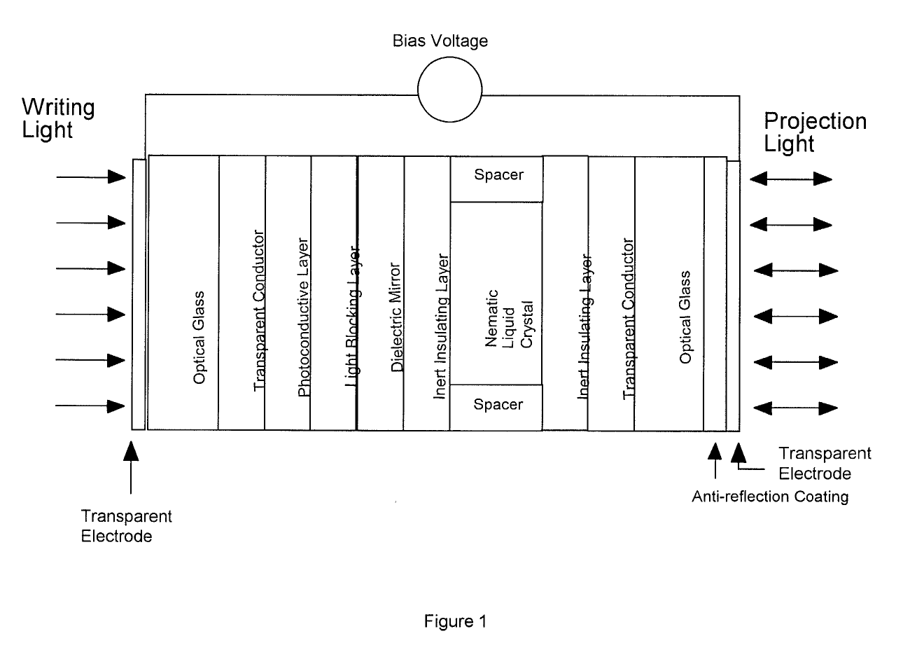

FIG. 1 is a conceptual drawing of an ILA (not to scale). Other than the spacers, each of the layers is typically a 50 millimeter by 50 millimeter square. A voltage is applied between the two transparent conductor layers.

When no light is impinging on the photoconductive layer, it represents a very high impedance. Thus, all of the voltage falls across it and none across the liquid crystal layer. The nematic liquid crystals are thus randomly arranged and the Projection Light hitting them is scattered randomly so that very little hits the dielectric mirror and virtually none escapes back out through the anti-reflection coating. This represents the black, or no light output.

Next, imagine a point of Writing Light passing through the optical glass and the transparent conductor layer and impinging on the photoconductive layer. At the point on the photoconductive layer where the point of light impinges, the resistance of the photoconductive layer is reduced. Since the Light Blocking, Dielectric Mirror and Inert Insulating Layers are all low resistivity, Some of the voltage applied across the transparent electrodes now falls across the Nematic Liquid Crystal, which causes the crystals to align themselves. Now, some of the Projection Light hits the dielectric mirror and is reflected back out the direction from whence it came.

There is an approximately linear relationship between the intensity of the writing light and the reflectivity of the output from the Projection Light. As the Writing Light is increased, a point is reached where the ILA saturates. Increasing the Writing Light beyond this point does not increase the light output.

If, instead of a point of light, a light pattern whose intensity varies with position is imaged onto the photoconductive layer, the output will be a much more intense replica of this input pattern. The impinging light can be an image and the output is a much higher power image.

The amount of bias voltage that falls across the liquid crystal material is determined by the resistance of the photoconductive layer, which, in turn is determined by the amount of impinging light at each point.

In current systems, the bias voltage is a fixed amplitude, fixed frequency oscillator. It is this frequency which beats with other frequencies created by the other signals, such as the input image sequence being changed 60 times per second when video is being projected.

Any smoothly varying periodic signal can be decomposed into a Fourier series. If the signal is repetitive, all of the constituent frequencies will beat with the modulating/modulated light signals. However, if the bias voltage frequency is randomly changed every period, none of the beat frequencies persist long enough to cause image degradation.

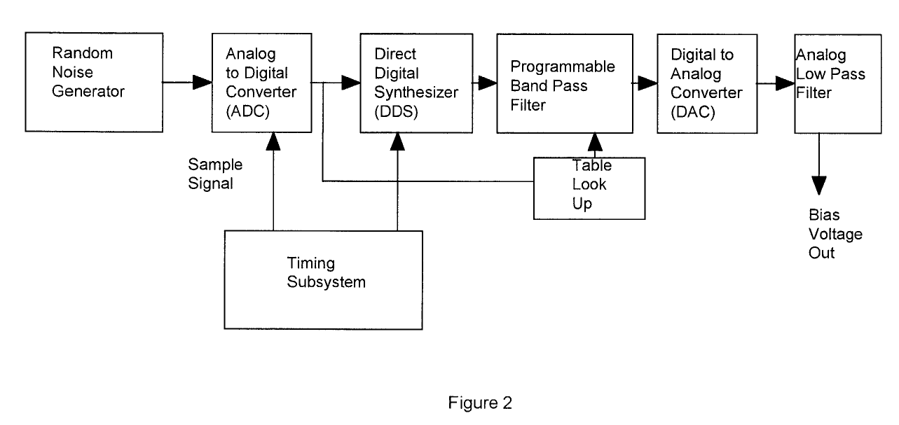

Referring to FIG. 2, the Random Noise generator creates an analog signal derived from a physical process such as the voltage across a resistor's terminals or a zener diode biased at its current/voltage knee. Under control of the Timing subsystem, the Random Noise Generator output is sampled by a 14 bit Analog to Digital Converter. This binary number is used to set the next period of a Direct Digital Synthesier (DDS). By means of a table look up function, the correct parameters for a band pass filter are also selected. The output of the DDS is then band pass filtered and presented to a Digital to Analog converter which outputs a smooth sinusoid with the period created by the DDS. The D to A output is low passed and then becomes the bias voltage.

Because the frequencies change every period, it does not exist long enough to create beat frequency large enough to be a problem.

What is claimed is:

1. An oscillator whose frequency is varied randomly every period.

2. A system which creates this oscillator.

3. A system which includes a timing subsystem which can vary the parameters of the bias voltage in an ILA projector.

4. A system which can produce a randomly variable frequency to prevent beat frequencies in any electronic system where beat frequencies can create a signal quality problem.

5. A frequency hopping system which can implement a spread spectrum system for signal security.

6. An image projection system comprising:
an image source;
a projector device;
a signal generator controlling the reception and projection of light images received by said projector device from said image source; and,
a variable frequency oscillator interconnected with said signal generator.

7. An image projection system according to claim 6, wherein said projector device is an image light amplifier.

8. An image projection system according to claim 6, wherein said signal generator is a bias voltage generator.

9. An image projection system according to claim 8, wherein said variable frequency oscillator includes a random signal generator generating a continually varying signal periodically sampled for changing a frequency of said bias voltage.

10. An image projection system according to claim 9, wherein said random signal generator is connected to an analog to digital converter which is connected to a direct digital synthesizer, said direct digital synthesizer generating a period according to information received from said random signal generator.

11. An image projection system according to claim 10, wherein said direct digital synthesizer is connected to a digital to analog converter, said digital to analog converter generating said bias voltage at a frequency set according to said continually varying signal from said random signal generator.

12. An image projection system according to claim 11, wherein a band pass filter is interposed between said direct digital synthesizer and said digital to analog converter.

13. An image projection system according to claim 11, wherein a low pass filter is connected to said digital to analog converter.

14. A method of projecting an image comprising:
generating a light image;
receiving said light image and amplifying said light image for projection;
controlling the receiving and amplifying of said light image with a control signal;
varying the frequency of said control signal during the receiving and amplifying of said light image so as to minimize beat frequencies of a projected image.

15. A method according to claim 14, wherein said control signal is a bias voltage.

16. A method according to claim 15, wherein varying of said frequency is performed using a variable frequency oscillator.

17. A method according to claim 15, wherein varying the frequency of said control signal includes:
randomly generating a signal;
periodically sampling said randomly generated signal;
selecting a period according to said sampled signal;
using said selected period to change the frequency of said bias voltage.

18. A method according to claim 17, wherein varying the frequency of said control system further includes:
selecting a band pass filter based on said selected period, and,
filtering said signal with said selected band pass filter.

19. A method according to claim 18, wherein selecting said period is performed by a direct digital synthesizer.

20. A method according to claim 18, wherein varying said frequency of said control system further includes filtering said signal with a low pass filter.
